(19) United States
(12) Patent Application Publication
(10) Pub. No.: US 2026/0227791 A1
(43) Pub. Date: Aug. 6, 2026

(54) Autonomous Work Vehicles, Methods of Controlling Autonomous work vehicles, and Method of Planning Operation of Autonomous work vehicles

(71) Applicant: Autonomous Solutions, Inc., Mendon, UT (US)

(72) Inventors: Garrett Winward, Mendon, UT (US); James Yonk, Mendon, UT (US); Jaremy Butler, Mendon, UT (US); Mckord Harris, Mendon, UT (US); Mike Hornberger, Mendon, UT (US); Nate Bunderson, Mendon, UT (US); Paul Lewis, Mendon, UT (US); David Hollingshead, Mendon, UT (US)

(73) Assignee: Autonomous Solutions, Inc., Mendon, UT (US)

(21) Appl. No.: 19/376,430

(22) Filed: Oct. 31, 2025

Related U.S. Application Data
(60) Provisional application No. 63/751,968, filed on Jan. 31, 2025.

(51) Int. Cl. G05D 1/622; G05D 1/246; G05D 1/248; G05D 1/65; G05D 109/10

(52) U.S. Cl. CPC G05D 1/622; G05D 1/246; G05D 1/248; G05D 1/65; G05D 2109/10

(57) ABSTRACT

An autonomous work vehicle is disclosed that includes a vehicle control unit; a location determining system; a digital storage medium comprising map data defining: a map comprising a path for the autonomous work vehicle to travel, at least one error polygon defined around the autonomous work vehicle within the map; and a controller in communication with the digital storage medium, location determining system, and the vehicle control unit, wherein the controller performs an off path error check in which the controller: retrieves the map data from the digital storage medium; receives current location data from the location determining system; locates the autonomous work vehicle on the map with the location data; determines whether the path is within the error polygon around the autonomous work vehicle; and if the path is not within the error polygon, the vehicle control unit performs a corrective action on the autonomous work vehicle.

### BACKGROUND

Autonomous work vehicles travel autonomously and must therefore be able to avoid obstacles, and in some cases to follow preset paths, to reduce the risk of the autonomous work vehicle getting stuck or of endangering people.

### SUMMARY

An autonomous work vehicle is disclosed, The autonomous work vehicle, for example, includes: a vehicle control unit; a location determining system; a digital storage medium including map data defining: a map including a path for the autonomous work vehicle to travel, at least one error polygon defined around the autonomous work vehicle within the map; and a controller in communication with the digital storage medium, location determining system, and the vehicle control unit, wherein the controller performs an off path error check in which the controller: retrieves the map data from the digital storage medium; receives current location data from the location determining system; locates the autonomous work vehicle on the map with the location data; determines whether the path is within the error polygon around the autonomous work vehicle; and if the path is not within the error polygon, the vehicle control unit performs a corrective action on the autonomous work vehicle.

In some examples, the map data may further define a vehicle polygon having vehicle polygon sides which define boundaries of the autonomous work vehicle within the map.

In some examples, the sides of the error polygon are defined at a predetermined normal distance from the vehicle polygon sides.

In some examples, the predetermined normal distance is based on an allowable off path error.

In some examples, the predetermined normal distance is variable around the autonomous work vehicle.

In some examples, the allowable off-path error is variable around the autonomous work vehicle.

In some examples, a hazard polygon is defined around the vehicle polygon and defines a hazard zone between the vehicle polygon and the hazard polygon, and wherein the controller determines whether an obstacle is located within the hazard zone, and if an obstacle is located within the hazard zone, the vehicle control system performs corrective action on the autonomous work vehicle.

In some examples, the allowable off path error is dynamically adjusted dependent on the location of the autonomous work vehicle on the map.

In some examples, the map data includes at least two error polygons, wherein each error polygon includes a different shape.

In some examples, an error polygon, from the at least two error polygons, is selected based on the location of the autonomous work vehicle on the map.

In some examples, the map includes undrivable zones defined as areas in which the autonomous work vehicle may not travel, and wherein the controller determines whether the error polygon intersects an undrivable zone, and if the error polygon intersects an undrivable zone, the vehicle control system performs corrective action on the autonomous work vehicle.

In some examples, the performing a corrective action on the autonomous work vehicle includes reducing the speed of the autonomous work vehicle, including stopping the autonomous work vehicle and/or steering the autonomous work vehicle back to the path.

In some aspects, the techniques described herein relate to a method of controlling an autonomous work vehicle, the method including: receiving location data from a location determining system on the autonomous work vehicle, receiving map data defining: a map including a path for the autonomous work vehicle to travel; and at least one error polygon defined around the autonomous work vehicle within the map; locating the autonomous work vehicle on the map with the location data; determining whether the path is within the error polygon; and if the path is not within the error polygon, performing a correction action on the autonomous work vehicle.

In some aspects, the techniques described herein relate to a method, wherein the map data further defines a vehicle polygon having vehicle polygon sides which define boundaries of the autonomous work vehicle within the map, and wherein sides of the error polygon are defined at a predetermined normal distance from the vehicle polygon sides.

In some aspects, the techniques described herein relate to a method, wherein a hazard polygon is defined around the vehicle polygon and defines a hazard zone between the vehicle polygon and the hazard polygon, and wherein the method includes determining whether an obstacle is located within the hazard zone, and if an obstacle is located within the hazard zone, performing a corrective action on the autonomous work vehicle.

In some aspects, the techniques described herein relate to a method, wherein the predetermined normal distance is based on an allowable off path error, the method further including dynamically adjusting the allowable off path error based on the location of the autonomous work vehicle on the map.

In some aspects, the techniques described herein relate to a method, wherein the map data includes at least two error polygons, the method further including: selecting an error polygon based on the location of the autonomous work vehicle on the map.

In some aspects, the techniques described herein relate to a method, wherein the map includes undrivable zones defined as areas in which the autonomous work vehicle may not travel, wherein the method includes determining whether the error polygon intersects an undrivable zone; and if the error polygon intersects an undrivable zone, performing a corrective action on the autonomous work vehicle.

In some aspects, the techniques described herein relate to a method, wherein performing a corrective action on the autonomous work vehicle includes reducing the speed of the autonomous work vehicle, including stopping the autonomous work vehicle; and steering the autonomous work vehicle back to the path.

In some aspects, the techniques described herein relate to a method of planning a route for an autonomous work vehicle, the method including: receiving map data defining: a map including a path for the autonomous work vehicle to travel, undrivable zones and/or obstacles on the map, the undrivable zones defined as areas in which the autonomous work vehicle may not travel, and at least one error polygon defined around the autonomous work vehicle within the map; generating a first plan for the autonomous work vehicle to follow the path with a maximum size error polygon; performing a plan check including: reviewing whether the error polygon intersects an undrivable zone and/or an obstacle at any point in the plan, and if the error polygon intersects an undrivable zone and/or an obstacle at any point in the plan, generating a new plan reducing the size of the error polygon where it intersects the undrivable zone and/or the obstacle; and if a new plan is generated when performing the plan check, repeating the plan check with the new plan.

The various examples described in the summary and this document are provided not to limit or define the disclosure or the scope of the claims.

### BRIEF DESCRIPTION OF THE FIGURES

FIG. 1 illustrates a block diagram of an example autonomous work vehicle communication system of the present disclosure.

FIG. 2 is a side view of an autonomous yard truck according to some embodiments.

FIGS. 3A-3C are plan views of digital representations of autonomous work vehicles with various error polygons and hazard polygons.

FIG. 4 shows example map data including a map of a work area with a path and various autonomous work vehicles positioned on the map.

FIG. 5 is a flow diagram showing steps of a method of controlling an autonomous work vehicle.

FIG. 6 is an example plan with a dynamic off-path error.

FIG. 7 is a flow diagram showing steps of a method of generating a route plan for an autonomous work vehicle.

FIG. 8 is a side view of an autonomous tractor according to some embodiments.

FIG. 9 is a side view of an autonomous mower according to some embodiments.

FIG. 10 is a block diagram of an example computational system (or controller).

### DETAILED DESCRIPTION

Systems and/or methods are disclosed for controlling an autonomous work vehicle and for planning control of an autonomous work vehicle.

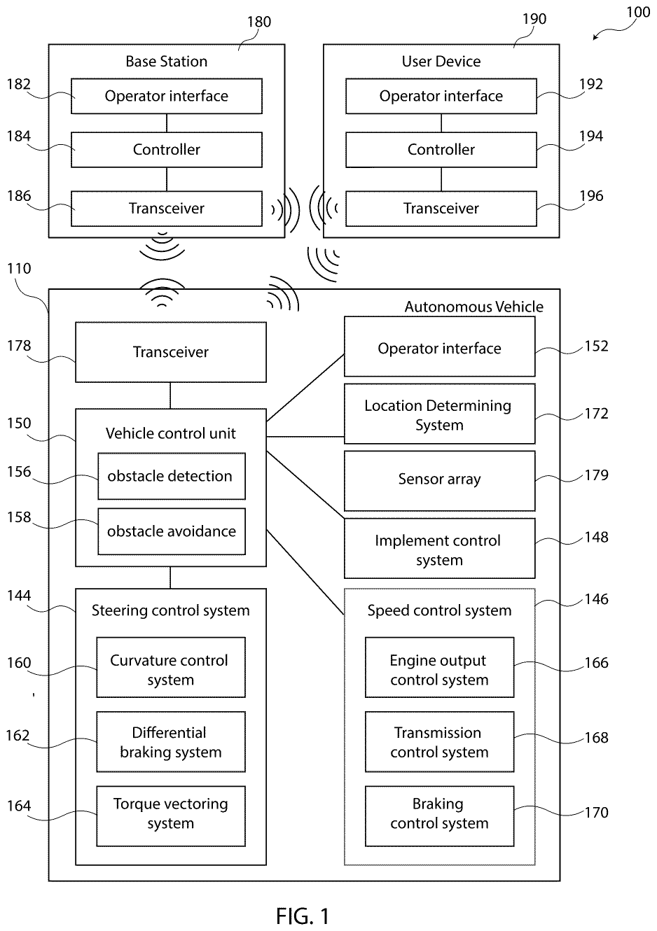

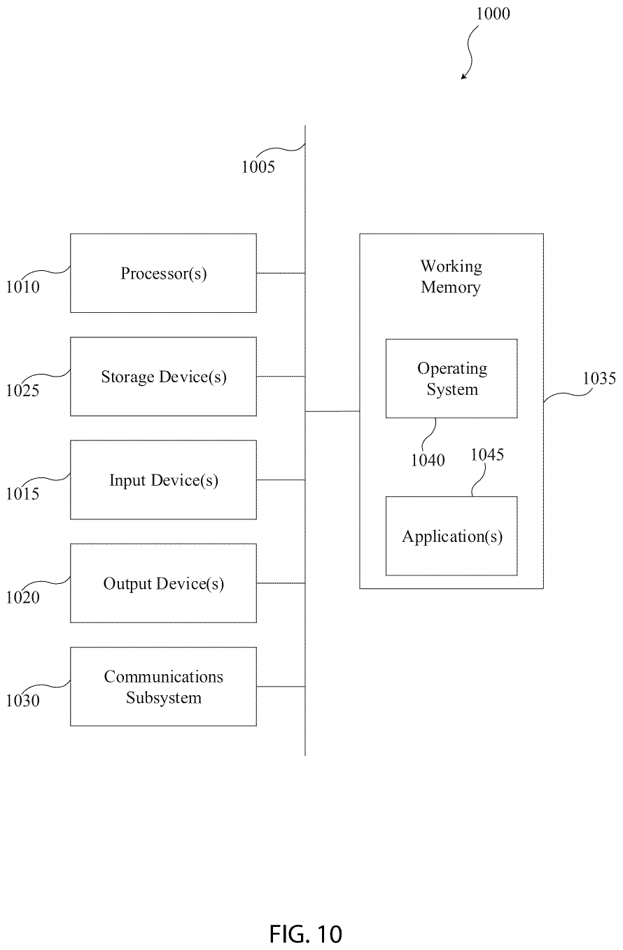

FIG. 1 is a block diagram of a communication and control system 100 that may be utilized in conjunction with the systems and methods of the disclosure. The communication and control system 100 may include a vehicle control unit 150 which may be mounted on an autonomous work vehicle 110. The autonomous work vehicle 110, for example, may include a yard truck, loader, wheel loader, track loader, dump truck, digger, backhoe, forklift, etc. The communication and control system 100, for example, may include any or all components of computational unit 1000 shown in FIG. 10.

For example, the autonomous work vehicle 110 may include a steering control system 144 that may control a direction of movement of the autonomous work vehicle 110. The steering control system 144, for example, may include any or all components of computational unit 1000 shown in FIG. 10.

The autonomous work vehicle 110, for example, may include a vehicle control system 146 that controls the speed, acceleration, and deceleration of the autonomous work vehicle 110. The vehicle control system 146, for example, may control the speed of the autonomous work vehicle 110 based on map data, control algorithms, obstacle detection, start and/or stop points, input from a base station 180, etc. The vehicle control system 146, for example, may include any or all components of computational unit 1000 shown in FIG. 10.

The autonomous work vehicle 110, for example, may include an implement control system 148 that may control operation of an implement towed by the autonomous work vehicle 110 or integrated within the autonomous work vehicle 110 or coupled to the autonomous work vehicle 110. The implement control system 148 may, for example, include any type of implement such as, for example, a bucket, a shovel, a blade, a thumb, a dump bed, a plow, an auger, a trencher, a scraper, a broom, a hammer, a grapple, forks, boom, spears, a cutter, a wrist, a tiller, a rake, etc. The implement control system 148, for example, may include any or all components of computational unit 1000 shown in FIG. 10.

The autonomous work vehicle 110, for example, may include a location determining system 172 which may determine the location of the autonomous work vehicle 110, for example, with reference to a map. The location determining system 172 may include a global positioning system (GPS) device. In other examples, the location determining system 172 may include any suitable sensors for determining a location of the autonomous work vehicle 110.

The vehicle control unit 150 may be communicatively coupled with the steering control system 144, the vehicle control system 146, the implement control system 148, and the location determining system 172. The vehicle control unit 150, for example, may include any or all the components shown in FIG. 10. The vehicle control unit 150, for example, may be integrated into a single controller or may include a plurality of distinct components or controllers. The vehicle control unit 150 may also be coupled with one or more sensors from the sensor array 179 and/or location determining system 172, and receive sensor data from the sensor array 179 and/or the location determining system 172. In some examples, the location determining system 172 may be a part of the vehicle control unit 150 and the sensor array 179. For example, the sensor array 179 may comprise location sensors, and the vehicle control unit 150 may comprise a processing algorithm for determining the location of the autonomous work vehicle 110 from signals received from the locating sensors.

The vehicle control unit 150, for example, may be used to control various aspects of the vehicle such as, for example, sending instructions to the steering control system 144, implement control system 148, vehicle control system 146, location determining system 172 etc. The vehicle control unit 150, for example, may include a vehicle artificial intelligence (VAI) that may include one or more processors that execute one or more algorithms.

The vehicle control unit 150, for example, may receive signals relative to many parameters of interest including, but not limited to: vehicle position/location, vehicle speed, vehicle heading, desired path location, off-path normal error, desired off-path normal error, heading error, vehicle state vector information, curvature state vector information, turning radius limits, steering angle, steering angle limits, steering rate limits, curvature, curvature rate, rate of curvature limits, roll, pitch, rotational rates, acceleration, and the like, or any combination thereof. These signals, for example, may come from the sensory array 179 or from the base station 180.

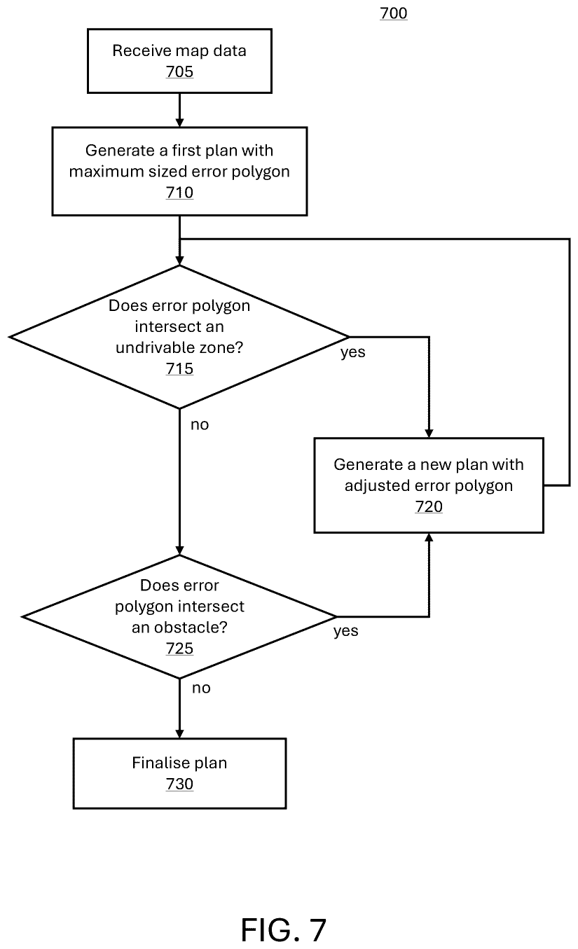

The vehicle control unit 150, for example, may be an electronic controller with electrical circuitry configured to process data from the various components of the autonomous work vehicle 110. The vehicle control unit 150 may include any or all a processor, such as the processor 1010, and a working memory 1035. The vehicle control unit 150 may also include one or more storage devices and/or other suitable components of computational system 1000. The processor 154 may be used to execute software, such as software for calculating drivable path plans or off-path error plans, such as described with reference to FIG. 7. Moreover, the processor 154 may include multiple microprocessors, one or more “general-purpose” microprocessors, one or more special-purpose microprocessors, and/or one or more application specific integrated circuits (ASICS), or any combination thereof. For example, the processor 154 may include one or more reduced instruction set (RISC) processors. The vehicle control unit 150, for example, may include any or all the components show in FIG. 10.

The vehicle control unit 150, for example, may include a digital storage medium which may include a volatile memory, such as random access memory (RAM), and/or a nonvolatile memory, such as ROM (e.g., working memory 1035 and/or storage device 1025). The memory may store a variety of information and may be used for various purposes. For example, the memory may store processor-executable instructions (e.g., firmware or software) for the vehicle control unit 150 to execute, such as instructions for calculating drivable path plan and/or for calculating off-path error plans, and/or controlling the autonomous work vehicle 110. The memory may include flash memory, one or more hard drives, or any other suitable optical, magnetic, or solid-state storage medium, or a combination thereof. The memory may store data such as vehicle characteristics, field maps, map data, software or firmware instructions and/or any other suitable data. The map data may include maps of desired paths for the autonomous work vehicle 110 to travel. The map data may, in some examples, include one or more error polygons for defining an area around the autonomous work vehicle 110 within which a path must be located, in other words, defining an allowable off-path error around the autonomous work vehicle 110. Each error polygon may be associated with a particular area of the map. In other examples, the digital storage medium may be located at the base station 180. In further examples, at least some of the information may be shared across a digital storage medium on the autonomous work vehicle 110 and a digital storage medium on the base station 180. The base station, for example, may have a library of different error polygons for each autonomous work vehicle in a work zone based on different off-path errors for different points within the map. The digital storage medium of the base station 180 may transmit an appropriate error polygon to the autonomous work vehicle 110, which may store the appropriate error polygon in the digital storage medium for use. When a different error polygon becomes appropriate, the base station 180 may transmit the new appropriate error polygon to the autonomous work vehicle 110 which may then store the new appropriate error polygon and may keep or discard the preceding error polygon.

The steering control system 144, for example, may include a curvature rate control system 160, a differential braking system 162, a steering mechanism, and a torque vectoring system 164 that may be used to steer the autonomous work vehicle 110. The curvature rate control system 160, for example, may control a direction of an autonomous work vehicle 110 by controlling a steering control system of the autonomous work vehicle 110 with a curvature rate, such as an Ackerman style autonomous work vehicle, 110 or articulating vehicle. The curvature rate control system 160, for example, may automatically rotate one or more wheels or tracks of the autonomous work vehicle 110 via hydraulic or electric actuators to steer the autonomous work vehicle 110. By way of example, the curvature rate control system 160 may rotate front wheels/tracks, rear wheels/tracks, and/or intermediate wheels/tracks of the autonomous work vehicle 110 or articulate the frame of the vehicle, either individually or in groups. The differential braking system 162 may independently vary the braking force on each lateral side of the autonomous work vehicle 110 to direct the autonomous work vehicle 110. Similarly, the torque vectoring system 164 may differentially apply torque from the engine to the wheels and/or tracks on each lateral side of the autonomous work vehicle 110. While the illustrated steering control system 144 includes the curvature rate control system 160, the differential braking system 162, and the torque vectoring system 164, the steering control system 144 may include one or more of these systems. Further examples may include a steering control system 144 having other and/or additional systems to facilitate turning the autonomous work vehicle 110 such as an articulated steering control system, a differential drive system, and the like.

The vehicle control system 146, for example, may include an engine output control system 166, a transmission control system 168, and a braking control system 170. The engine output control system 166 may vary the output of the engine to control the speed of the autonomous work vehicle 110. For example, the engine output control system 166 may vary a throttle setting of the engine, a fuel/air mixture of the engine, a timing of the engine, and/or other suitable engine parameters to control engine output. In addition, the transmission control system 168 may adjust gear selection within a transmission to control the speed of the autonomous work vehicle 110. Furthermore, the braking control system 170 may adjust braking force to control the speed of the autonomous work vehicle 110. While the illustrated vehicle control system 146 includes the engine output control system 166, the transmission control system 168, and the braking control system 170, the vehicle control system 146 may include one or two of these systems. The vehicle control system 146, for example, may also include other systems and/or additional systems that may be used to control the speed of the autonomous work vehicle 110.

The implement control system 148, for example, may control various parameters of the implement towed by and/or integrated within the autonomous work vehicle 110. For example, the implement control system 148 may instruct an implement controller via a communication link, such as a CAN bus, ISOBUS, Ethernet, wireless communications, and/or Broad R Reach type Automotive Ethernet, etc.

The implement control system 148, for example, may instruct an implement controller to adjust a penetration depth of at least one ground engaging tool of an agricultural implement, which may reduce the draft load on the autonomous work vehicle 110.

The implement control system 148, as another example, may instruct the implement controller to transition an agricultural implement between a working position and a transport portion, to adjust a flow rate of product from the agricultural implement, to adjust a position of a header of the agricultural implement (e.g., a harvester, etc.), among other operations, etc.

The implement control system 148, as another example, may instruct the implement controller to adjust a shovel height, a shovel angle, a shovel position, etc.

The location determining system 172 may include a sensor or more than one sensor to determine the location of the autonomous work vehicle 110. For example, the location determining system 172 may comprise a GPS device, or may comprise sensors which can detect the landscape around the autonomous work vehicle 110 to deduce the location of the autonomous work vehicle 110. In some examples, the location determining system 172 may comprise known landmarks, or installed landmarks with readable tags so that, when the autonomous work vehicle passes the readable tags and reads the readable tags, the location of the autonomous work vehicle 110 can be inferred.

The communication and control system 100, for example, may include a sensor array 179. The sensor array 179, for example, may facilitate determination of condition(s) of the autonomous work vehicle 110 and/or the work area. For example, the sensor array 179 may include one or more sensors (e.g., infrared sensors, ultrasonic sensors, magnetic sensors, tachometer, radar sensors, Lidar sensors, terahertz sensors, sonar sensors, wheel encoders, cameras, etc.) that monitor a rotation rate of a respective wheel or track and/or a ground speed of the autonomous work vehicle 110. The sensors may also monitor operating levels (e.g., temperature, fuel level, etc.) of the autonomous work vehicle 110. Furthermore, the sensors may monitor conditions in and around the work area, such as temperature, weather, wind speed, compass, humidity, and other conditions. The sensors of the sensor array 179, for example, may detect physical objects in the work area, such as a parking stall, a material stall, accessories, other vehicles, obstacles, environmental features, or other object(s) that may be in the area surrounding the autonomous work vehicle 110. The physical objects detected in the work area by the sensor array 179 may be continuously overlaid onto the map, to update the map with the physical objects as they are detected. The physical objects may be retained on the map until the sensor array 179 returns to the same area and no longer senses the physical object.

The sensor array 179, for example, may include a velocity sensor which may include one or more of an inertial measurement unit, a compass, a GPS sensor, a wheel encoder, a tachometer, a camera, a radar, etc. The sensor array 179, for example, may also include a steering angle sensor. The velocity sensor, for example, may produce velocity data. Velocity data may include speed and/or bearing. Velocity data, for example, may also include steering angular rate.

The operator interface 152, for example, may be communicatively coupled to the vehicle control unit 150 and configured to present data from the autonomous work vehicle 110 via a display. Display data may include: data associated with operation of the autonomous work vehicle 110, data associated with operation of an implement, a map, position of the autonomous work vehicle 110 (e.g. on a map), a speed of the autonomous work vehicle 110, a desired path (e.g. on a map), a drivable path plan (e.g., on a map), a target position, a current position, etc. The operator interface 152 may enable an operator to control certain functions of the autonomous work vehicle 110 such as starting and stopping the autonomous work vehicle 110, inputting a desired path, etc. The operator interface 152, for example, may enable the operator to input parameters that cause the vehicle control unit 150 to adjust the drivable path plan. For example, the operator may provide an input requesting that the desired path be acquired as quickly as possible, that an off-path normal error be minimized or maximized, that a speed of the autonomous work vehicle 110 remain within certain limits, that a lateral acceleration experienced by the autonomous work vehicle 110 remain within certain limits, etc. In addition, the operator interface 152 (e.g., via the display, or via an audio system (not shown), etc.) may alert an operator if the desired path cannot be achieved, for example.

The vehicle control unit 150, for example, may include the base station 180 having a base station controller 184 located remotely from the autonomous work vehicle 110. For example, the control functions of the vehicle control unit 150 may be distributed between the vehicle control unit 150 of the autonomous work vehicle control unit 150 and the base station controller 184. The base station controller 184, for example, may be in communication with the location determining system 172, the vehicle control unit 150 and a digital storage medium, which may be within the vehicle control unit 150 or on the base station 180. The base station controller 184, for example, may perform a substantial portion of the control functions of the vehicle control unit 150. For example, a first transceiver 178 positioned on the autonomous work vehicle 110 may output signals indicative of vehicle characteristics (e.g., position, speed, heading, curvature rate, curvature rate limits, maximum turning rate, minimum turning radius, steering angle, roll, pitch, rotational rates, acceleration, etc.) to a second transceiver 186 at the base station 180. The base station controller 184, for example, may calculate drivable path plans (such as described with reference to FIG. 7), and/or output control signals to control the curvature rate control system 160, the speed control system 146, and/or the implement control system 148 to direct the autonomous work vehicle 110 toward the desired path or to stop the autonomous work vehicle 110, for example. The base station controller 184, for example, may store a library of error polygons and may output an appropriate error polygon to the autonomous work vehicle 110 dependent on the path, location on the map and/or vehicle characteristics of the autonomous work vehicle 110. The base station controller 184 may include a processor and memory device having similar features and/or capabilities as the processor and the memory device discussed previously. Likewise, the base station 180 may include an operator interface 182 having a display, which may have similar features and/or capabilities as the operator interface 152 and the display discussed previously.

In some embodiments, the base station 180 and/or the autonomous work vehicle 110 may be in communication with a user device 190. A user device may include a phone, tablet, laptop, or computer. The user device 190, for example, can include an application that allows the user to communicate commands to the autonomous work vehicle 110 and/or receive information about the autonomous work vehicle 110. Alternatively or additionally, the user device 190, for example, can include an application that allows the user to observe the autonomous work vehicle 110 move through a map of the work area where the autonomous work vehicle operates.

The user device 190, for example, may include an application that can receive any of the user inputs disclosed in this document. The user device 190, for example, may include an application that can display any of the information disclosed in this document.

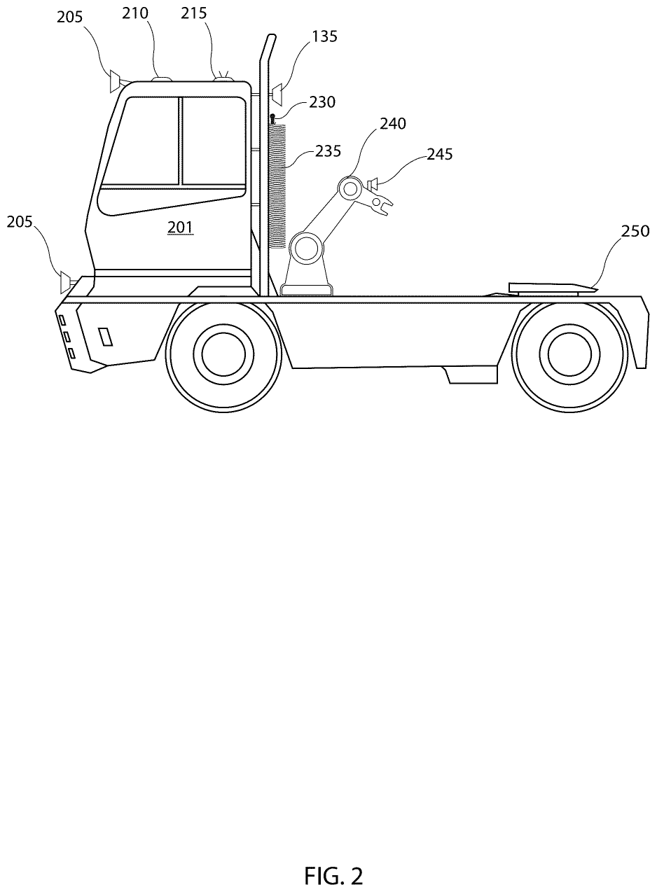

FIG. 2 is a side view of an autonomous yard truck 200 according to some embodiments. The autonomous yard truck 200 includes a cab 201 that may be used to drive the autonomous yard truck 200 manually. The autonomous yard truck 200 may include one or more controllers as shown in FIG. 1. The autonomous yard truck 200 may also include a brake system, an engine, a transmission, steering, etc.

In some embodiments, the autonomous yard truck 200 may include a sensor array (e.g., sensor array 179) that includes sensors 205 disposed at various locations on the autonomous yard truck 200 such as, for example, on the cab 201, bumper, housing, frame, etc. The sensors 205 may include infrared sensors, ultrasonic sensors, magnetic sensors, radar sensors, Lidar sensors, terahertz sensors, sonar sensors, cameras, etc. The autonomous yard truck 200 may also include one or more backup sensors 135 such as, for example, infrared sensors, ultrasonic sensors, magnetic sensors, radar sensors, Lidar sensors, terahertz sensors, sonar sensors, cameras, etc.

In some embodiments, the autonomous yard truck 200 may include a spatial locating device (or GPS) antenna 210. In some embodiments, the autonomous yard truck 200 may include a transceiver antenna 215. The spatial locating device antenna 210 and transceiver antenna 215 may form a part of a location determining device 172 of FIG. 1, for example.

In some embodiments, the autonomous yard truck 200 may include one or more hoses 235 that can be connected with the trailer 260 such as, for example, two or three hoses. Each hose may have a hose connector 230 that can be connected with a trailer hose connector 265. For example, the autonomous yard truck 200 may include a service brake hose, an emergency brake hose, and/or a refrigerant hose.

In some embodiments, the autonomous yard truck 200 may include a robotic arm 240 disposed on the back bed of the autonomous yard truck 200. The robotic arm 240 may include any type of robotic arm. The robotic arm 240, for example, may exert high torque or high pressure sufficient to connect the hose connector 230 with the trailer hose connector 265. The hose connector 230 and/or the trailer hose connector 265 may comprise a glad-hand connector. In some embodiments, when the autonomous yard truck 200 is not coupled with a trailer 260, the hose connector 230 may be positioned in a storage rack at some point on the autonomous yard truck 200 such as, for example, on the rear of the cab 201.

In some embodiments, the robotic arm 240 may include one or more arm sensors 245 such as, for example, infrared sensors, ultrasonic sensors, magnetic sensors, radar sensors, Lidar sensors, terahertz sensors, sonar sensors, cameras, etc. The arm sensor 245, for example, may produce data that can be used to identify the location of a hose connector 230 and/or a trailer hose connector 265. The arm sensor 245, for example, may produce data that can show that a hose connector 230 and/or a trailer hose connector 265 are sufficiently coupled.

In some embodiments, the autonomous yard truck 200 may include a fifth-wheel coupling 250. The fifth-wheel coupling 250, for example, may be raised or lowered with a fifth-wheel coupling boom. FIG. 2 shows the fifth-wheel coupling 250 in a lowered position. The fifth-wheel coupling 250 may couple with a kingpin 255 of a trailer 260.

When the fifth-wheel coupling 250 is coupled with a kingpin 255 and the fifth-wheel coupling 250 is in the raised fifth-wheel coupling 250 position, the trailer legs 270 may lifted off the ground. This may allow the autonomous yard truck 200 to pull the trailer 260 without individually raising the trailer legs 270.

In some embodiments, the robotic arm 240 and/or the arm sensor 245 may be coupled with a thermal management system. A thermal management system may, for example, be coupled with a thermal management system associated with the autonomous yard truck 200 such as, for example, coupled with the cab heating/cooling system and/or the engine heating/cooling system. A thermal management system may, for example, be an independent system that heats and/or cools the robotic arm 240 and/or the arm sensor 245. A thermal management system may, for example, keep the temperature of the robotic arm 240 and/or the arm sensor 245 between about 32° F. and about 100° F.

In some embodiments, the autonomous yard truck 200 may include a deployable shade coupled with the back of the cab 201. The deployable shade, for example, may be used to screen the sun and/or other lighting from the arm sensor 245 and/or the one or more backup sensors 135. The deployable shade, for example, may include an umbrella configuration or an awning configuration. The deployable shade, for example, may be coupled with the roof or an upper portion of the cab.

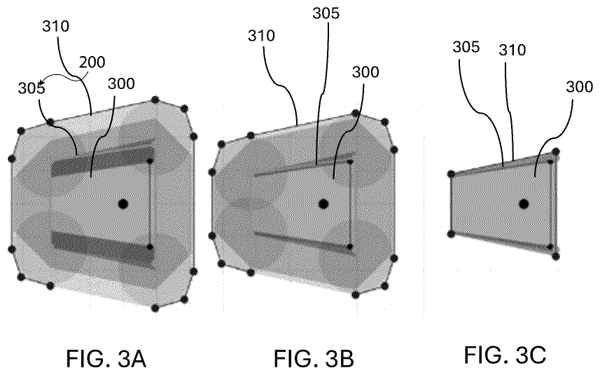

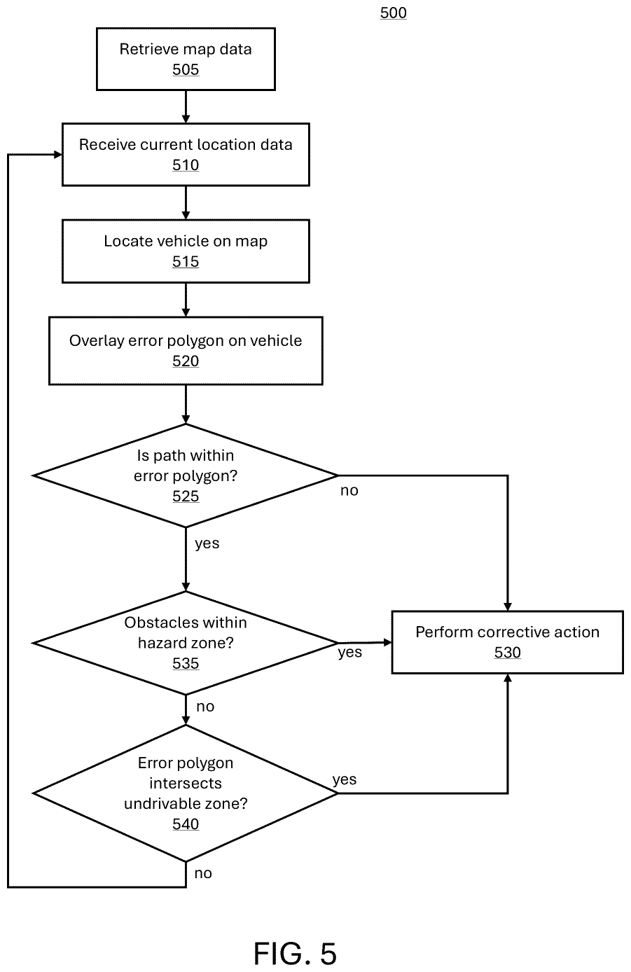

FIGS. 3A-3C show example digital representations of autonomous work vehicles 110 with associated vehicle polygons 300, error polygons 305 and hazard polygons 310, each of which may be overlaid onto a map 400 and may be used in the methods described with reference to FIGS. 5 and 7.

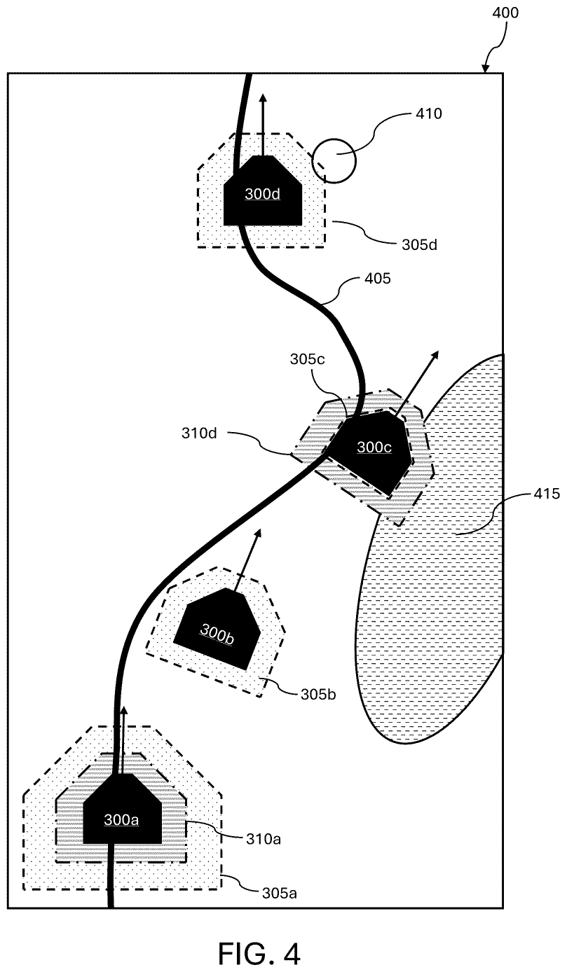

The vehicle polygons 300 may have vehicle polygon sides which define boundaries (i.e., edges) of the autonomous work vehicle 110. These vehicle polygons 300 may be overlaid onto a map 400 (shown in FIG. 4) to represent the autonomous work vehicle 110 on the map 400. In other words, the vehicle polygon 300 may be associated with a particular autonomous work vehicle 110 and may represent a plan outline of the autonomous work vehicle 110 on the map 400. The vehicle polygon 300 can be substantially the same size and/or shape as the planar surface area or a planar cross section of the autonomous work vehicle 110 when scaled on the map 400. The vehicle polygon 300 may include multiple vertices and have any shape. The vehicle polygon 300 may be created based on user input defining the shape and dimensions, or by selecting the autonomous work vehicle 110 type in a list stored in the memory, or it may be drawn by a user.

The error polygons 305 define an allowable off-path error around the autonomous work vehicle 110, the off-path error defined as the maximum allowable distance that an autonomous work vehicle 110 may deviate from the defined path which it should be following. Each error polygon 305 may have a substantially similar shape and/or size to the vehicle polygon 300, or may be larger than the vehicle polygon 300 and/or have a different shape.

Sides of an error polygon 305 may be defined at a predetermined normal distance from the vehicle polygon 300 sides. The predetermined normal distance may be the allowable off-path error, or may be based on the allowable off-path error. The predetermined normal distance may be variable around the autonomous work vehicle 110. In other words, the allowable off-path error may be variable around the autonomous work vehicle 110. For example, at the front of the autonomous work vehicle 110, the predetermined normal distance may be larger than at the rear of the autonomous work vehicle 110 or the predetermined normal distance may be larger on the sides of the autonomous work vehicle 110 than the front and rear of the autonomous work vehicle. The allowable off-path error may vary based on the location of the autonomous work vehicle 110.

In FIG. 3A, the error polygon 305 (i.e., the allowable off-path error) is defined 0.5 m away from the vehicle polygon 300 on the sides, and 0 m away from the vehicle polygon 300 at the front and rear (where the front of the vehicle polygon 300 is shown on the left side of the Figure). In FIGS. 3B and 3C, the error polygon 305 is defined 0.1 m away from the vehicle polygon 300 on the sides, and 0 m away from the vehicle polygon 300 at the front and rear (where the front of the vehicle polygon 300 is shown on the left side of the Figure). In some examples, the allowable off-path error, and therefore the error polygon 305 may be dynamically adjusted depending on the location of the autonomous work vehicle on the map 400. In other examples, depending on the location of the autonomous work vehicle 110 on the map 400, a suitable error polygon 305 may be selected from a library of error polygons 305.

The hazard polygon 310 is defined around the vehicle polygon 300, and defines a hazard zone between the hazard polygon 310 and the vehicle polygon 300 (i.e., around the autonomous work vehicle 110) within which there should be no obstacles, as this would present a hazard to the autonomous work vehicle 110. In some examples, it will be appreciated that the error polygon 305 and the hazard polygon 310 may be the same shape and/or size. For example, the hazard polygon 310 may be identical to the error polygon 305, and may therefore be represented by the error polygon 305. In other examples, the hazard polygon 310 may be larger or smaller than the error polygon 305.

FIG. 4 shows example map data, including an example map 400 of a work area (e.g., a golf course; an agricultural field; a construction work site; a truck yard, etc.) with representations of a path 405 for an autonomous work vehicle 110 to follow, a known obstacle 410 and an undrivable zone 415. In some examples, there may be no known obstacles 410 or undrivable zones 415, or there may be more than one known obstacle 410 and/or undrivable zone 415. The undrivable zone 415 is defined as an area in which the autonomous work vehicle 110 may not travel, such as fairways, or areas near fairways. The map 400, in this example, is overlaid with vehicle polygons 300a, 300b, 300c, 300d (to show example positions that the autonomous work vehicle 110 might be represented in) and corresponding error polygons 305a-d at varying locations on the map 400. The vehicle polygons 300a and 300c also have an associated hazard polygon 310a, 310c around them defining a hazard zone between each hazard polygon 310a, 310c and its corresponding vehicle polygon 300a, 300c. For vehicle polygons 300b, and 300d, the error polygons 305 define the respective hazard zones within them since they are the same size as the hazard polygon 310 would have been. The autonomous work vehicle 110 may receive instructions to drive along the path 405 represented on the map 400. As the autonomous work vehicle 110 is driving along the path 405 it may deviate off the path 405 by the allowable off-path error defined by the error polygon 305.

The map data may include a single error polygon 305 for the map 400 defining a default, or a predefined allowable off-path error around the autonomous work vehicle 110. In some examples, the single polygon 305 may be fixed in shape and/or size, or the single error polygon 305 may have a dynamically adjustable shape and/or size. In other example, there may be a library of error polygons 305 with differing allowable off-path errors, and therefore different shapes. The different shaped error polygons 305 may have similar profiles, but with differing dimensions. Where there are multiple error polygons 305, each error polygon 305 may be associated with a different area of the map 400, and/or may be associated with different parts of the path 405. The locations with different allowable off-path errors may be entered by a user, or in other examples locations may be automatically detected based on the path 405 and known obstacles 410 near the path.

For example, in FIG. 4, vehicle polygon 300a is located on the bottom of the map 400 and has a large error polygon 305a as there are no undrivable zones 415 nearby, such that the autonomous work vehicle 110 may deviate further from the path 405 without presenting a high risk of driving into an undrivable zone 415. In this example, a hazard polygon 310a is outlined between the error polygon 305a and the vehicle polygon 300a, since the error polygon 305a is so large that it is not necessary for the whole area within the error polygon 305a to be free of hazards. In other examples, there may be no hazard polygon 310a.

Vehicle polygon 300b is slightly further up the path from vehicle polygon 300a and has a smaller error polygon 305b because it is closer to an undrivable zone 415. For example, vehicle polygon 300b, the error polygon 305 is the same size as the hazard polygon 310 would be, and so no separate hazard polygon 310 is needed. Instead, in this example, the error polygon 305b defines the hazard zone between it and the vehicle polygon 300b. In other examples, there may be an additional hazard polygon.

Vehicle polygon 300c is at a point on the path 405 which is very close to the undrivable zone 415 and therefore has an error polygon 305c which is the same size and shape as the vehicle polygon 300c. In other words, there is no allowable off-path error for vehicle polygon 300c. It also has a hazard polygon 310c defined outside the error polygon 305c, defining the hazard zone between the hazard polygon 310c and the vehicle polygon 300c. In other examples, there may be no hazard polygon.

Vehicle polygon 300d, like vehicle polygon 300b has an error polygon 305d the same size as the hazard polygon 310 would be and so, in this example, the error polygon 305d also acts as the hazard polygon 310.

FIG. 5 is a flow chart showing steps of a method 500 of controlling an autonomous work vehicle (e.g., autonomous work vehicle 110, or autonomous yard truck 200) by performing an off-path error check. The off-path error check may be performed by any suitable controller, such as the base station controller 184 in FIG. 1, or the controller of the vehicle control unit 150.

In block 505, the method 500 may comprise retrieving map data, for example, from a digital storage medium. The map data may include, for example, the map 400 comprising the path 405, the obstacles 410 and the undrivable zones 415 (e.g., as shown in FIG. 4). The map data may also include at least one vehicle polygon 300 associated with the autonomous work vehicle 110 and at least one error polygon 305. Where there are multiple error polygons 305, each error polygon 305 may be associated with a different location on the path 405 or the map 400. From block 505, the method 500 may proceed to block 510.

In block 510, the method 500 may comprise receiving current location data from, for example, the location determining system 172 of the autonomous work vehicle 110 of FIG. 1. From block 510, the method 500 may proceed to block 515.

In block 515, the method 500 may comprise locating the autonomous work vehicle 110 on the map 400. This may comprise using the location data to determine the location of the autonomous work vehicle 110 relative to the map 400, and overlaying the autonomous work vehicle 110 on the map 400. Locating the autonomous work vehicle 110 on the map 400 may include overlaying the vehicle polygon 300 on the map. The vehicle polygon 300 can move throughout the map 400 of a work area as the autonomous work vehicle 110 moves throughout the work area. From block 515, the method 500 may proceed to block 520.

In block 520, the method 500 may comprise overlaying an error polygon 305 on the map 400, around the vehicle polygon 300. In FIG. 4, several examples of vehicle polygons 305a-305d are shown at various locations on the map 400, each vehicle polygon 300 surrounded by a corresponding error polygon 305a-305d. There may be a default error polygon 305 with a default allowable off-path error, or in some examples, there may be a library of error polygons 305 to choose between, and an error polygon 305 may be selected from the library based on the location of the autonomous work vehicle 110 on the map 400 and/or the path 405. For example, at a location where the path 405 is very close to the undrivable zone 415 (such as when it is on a bridge, or between two objects, areas at the edge of a work zone, areas near human activity) a smaller error polygon 305c may be selected compared to a location where the path 405 is further away from the undrivable zone 415 where a larger error polygon 300a, 300b, 300d may be selected. While the autonomous work vehicle 110 is driving, it may proceed to areas of the map 400 with different allowable off-path errors, and so an updated error polygon 305 may be selected.

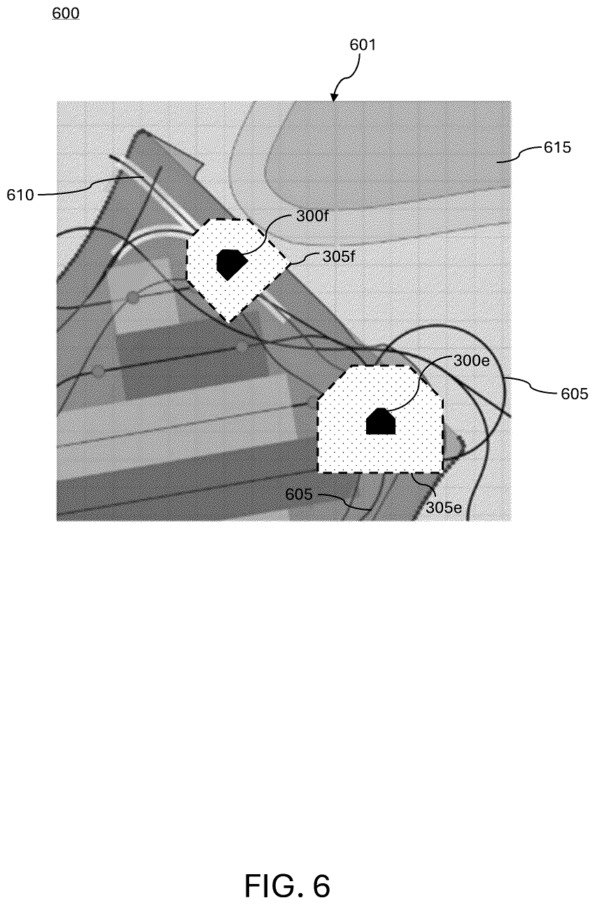

In yet further examples, the overlaid error polygon 305 may be dynamically adjusted as the autonomous work vehicle 110 moves, in other words, as the vehicle polygon 300 is moved throughout the map 400. For example, FIG. 6 shows a plan 600 including a map 601 with a plurality of paths 605 which an autonomous work vehicle 110, such as an autonomous mower, could take. A dynamic off-path error may be applied to the map 601, where a lower-error portion 610 of the map (represented with a thick white line) requires that the autonomous work vehicle 110 maintain a lower off-path error than on the rest of the map 601 since it brings the autonomous work vehicle 110 in very close proximity to a bunker 615 (represented by a green shape), which may be considered to be an undrivable zone. Returning to FIG. 5, from block 520, the method 500 may proceed to block 525.

In block 525, the method 500 may comprise determining whether the path 405 is within the error polygon 305 around the autonomous work vehicle 110. For example, vehicle polygons 300a, 300c and 300d each have a respective error polygon 305a, 305c, 305d which clearly overlaps with the path 405. Therefore, for vehicle polygons 300a, 300c, 300d the path 405 is within the error polygon 305a. In this case, where it is determined that the path 405 is within the error polygon 305, the method proceeds to block 535. In some examples of the method 500, block 535 may be omitted, in which case the method would proceed directly to block 540. For vehicle polygon 300b, it has a corresponding error polygon 305b which clearly does not overlap with the path 405. Therefore, for vehicle polygon 300b the path 405 is not within the error polygon 305b. In this case, where it is determined that the path 405 is not within the error polygon 305, the method 500 may proceed to block 530.

In block 530, the method 500 may comprise performing a corrective action on the autonomous work vehicle 110. For example, in an autonomous work vehicle 110, the vehicle control unit 150 may control the autonomous work vehicle 110 to reduce its speed, or to stop, or may control the autonomous work vehicle 110 to steer it back to the path 405. For example, the autonomous work vehicle 110 associated with vehicle polygon 300b may be stopped, slowed down or steered back towards the path 405. In an example where the base station controller 184 performs the off-path error check, the base station controller 184 may send instructions to the vehicle control unit 150 to perform the corrective action on the autonomous work vehicle 110. In other examples, a controller in the vehicle control unit 150 may perform the off-path error check, and may therefore directly perform the corrective action in block 530.

In block 535, the method 500 may comprise determining whether there are obstacles within the hazard polygon 410 in examples where the vehicle polygon 300 has an associated hazard polygon 310, such as the vehicle polygons 300a and 300c in FIG. 4, which have associated hazard polygons 310a and 310d. In example vehicle polygons 300b and 300d, where there is no separate hazard polygon 310, the method 500 may comprise determining whether there are obstacles within the error polygon 305. If it is determined that there is an obstacle within the hazard polygon 310 (or error polygon 305 when it takes the place of a hazard polygon 310), this means that there is a high risk of a collision, and so the method 500 may proceed to block 530. For example, the hazard polygon 310d associated with vehicle polygon 300d in FIG. 4 is clearly overlapping the obstacle 410, such that it would be determined that there is an obstacle 410 in the hazard polygon 310d. In some examples, where there is no associated hazard polygon 310, such as for vehicle polygons 300b and 300d, block 535 may be omitted.

In block 540, the method 500 may comprise determining whether the error polygon 305 intersects an undrivable zone 415. For example, due to the proximity of the path 405 to the undrivable zone 415, the error polygon 305c clearly intersects an undrivable zone 415, even though it is still on the path 405. When it is determined that the error polygon 305 intersects an undrivable zone, the method 500 may proceed to block 530. If it is determined that the error polygon 305 does not intersect an undrivable zone 415, the method 500 may return to block 510, and the autonomous work vehicle 110 may continue unimpeded.

FIG. 7 is a flow chart showing steps of a method 700 of planning a route for an autonomous work vehicle 110, and generating a route plan, such as the plan of FIG. 6.

In block 705, the method 700 may comprise receiving map data. The map data may comprise a map 601 comprising a path 605 (shown in FIG. 6) for the autonomous work vehicle 110 to travel. The map data may comprise identified undrivable zones 615 or obstacles on the map 601, where the undrivable zones 615 are similar to the undrivable zones in FIG. 4, in that they are defined as areas in which the autonomous work vehicle 110 may not travel. The map data may include an error polygon 305 which is either dynamically adjustable in shape and size, or at least two error polygon 305 in a library of error polygons 305. In this example, the error polygon 305 may also define the hazard polygon 310 (in other words, the error polygon 305 and the hazard polygon 310 are the same size and shape, and the error polygon 305 may be treated additionally as a hazard polygon 310). From block 705, the method may proceed to block 710.

In block 710, the method 700 may comprise generating a first plan for the autonomous work vehicle 110 to follow the path 605 with a default size error polygon 305, which will be referred to as a first error polygon 305e shown in FIG. 6. This may include overlaying a vehicle polygon 300e on the map 601 to represent the autonomous work vehicle 110, and overlaying the first error polygon 305e around the vehicle polygon 300e. The default size error polygon 305e may be a maximum size error polygon 305e. Beginning with the maximum size error polygon 305e gives the autonomous work vehicle 110 more flexibility for errors and deviations from the path 605 without interrupting its movement. From block 710, the method may proceed to block 715. Blocks 715, 720 and 725 may collectively be referred to as performing a plan check.

In block 715, the method 700 may comprise reviewing whether the first error polygon 305e intersects an undrivable zone 615 during its movement along the path 605. In other words, in the plan while the vehicle polygon 300e moves throughout the map 601 along the path 605, it is determined whether, at any point along the path 605, the first error polygon 305e intersects an undrivable zone 615. If it is determined that the first error polygon 305e intersects an undrivable zone 615 in the plan, the method may proceed to block 720. If it is determined that the first error polygon 305e does not intersect an undrivable zone 615 in the plan, the method may proceed to block 725.

In block 720, the method 700 may comprise generating a new plan, in which the first error polygon 305e is reduced in size to at some portion of the map 601. In this example, the first error polygon 305 may be reduced in size where it intersects the undrivable zone 615 to a second error polygon 305f (shown in FIG. 6) which may be smaller than the first error polygon 305e. From block 720, the method may return to block 715 to repeat the plan check, this time with the new plan comprising the dynamically adjusting error polygon 305.

In block 725, the method 700 may comprise reviewing whether the error polygons 305e, 305f intersects an obstacle. In other words, in the plan while the vehicle polygon 300e, 300f moves throughout the map 601 along the path 605, it is determined whether, at any point along the path 605, the error polygon 305e, 305f intersects an obstacle. If it is determined that the error polygon 305 intersects an obstacle in the plan, the method may proceed to block 720, in which the error polygon 305 is reduced in size where it intersects the obstacle. If it is determined that the error polygon 305 does not intersect an obstacle in the plan, the method may proceed to block 730. In examples where there is a hazard polygon 310 which is distinct from the error polygon 305, block 725 may comprise reviewing whether the hazard polygon 310 intersects an obstacle.

At block 730, the method 700 may comprise finalizing the plan with the dynamically adjusted error polygon 305e, 305f to create a “valid plan”. Creating a plan with this method may allow for reduced off-path checks while the autonomous work vehicle 110 is in operation in an area, for example, where there are fewer undrivable zones or obstacles. A “valid plan” may be rejected or accepted by an operator. The information in the plan may be used to modify conditions of the work area to make it more suitable for autonomous operations (e.g., mowing, moving fairway boundaries, trimming trees, etc.).

It will be appreciated that, while the method described above performs block 715 before block 725, in other examples, block 725 may be performed before block 715. In further examples, either of block 715 or block 725 may be omitted.

The order of the various blocks in processes described with reference to FIGS. 5 and 7 can occur in any order. Additionally or alternatively, one or more blocks may be skipped, one or more blocks may be performed in parallel, and/or one or more blocks may be combined, and/or one or more blocks may be performed in any number of sub-blocks.

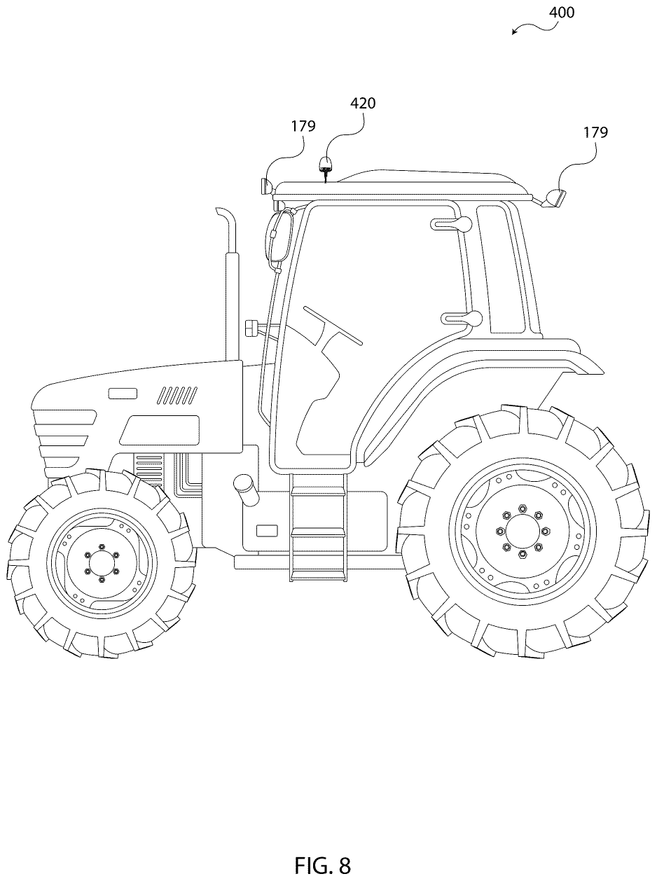

FIG. 8 is a sideview of an example autonomous tractor 400, which may include all or some of the components of autonomous work vehicle 110. The autonomous work vehicle in this document may include the autonomous tractor 400. In this example, the autonomous tractor 400 may include standard tractor equipment and/or components. The autonomous tractor 400 may include or be coupled with any kind of implement such as, for example, plow, disc plow, reel mower, dumper, lift, bucket, shovel, blade, cutter, etc. The autonomous tractor 400, for example, includes a sensor array 179 (or multiple sensor arrays). The sensor array 179 may include, for example, one or more lidar, radar, and/or video cameras. The video cameras, for example, may include 360 degree cameras, a front facing camera, and/or a back facing camera.

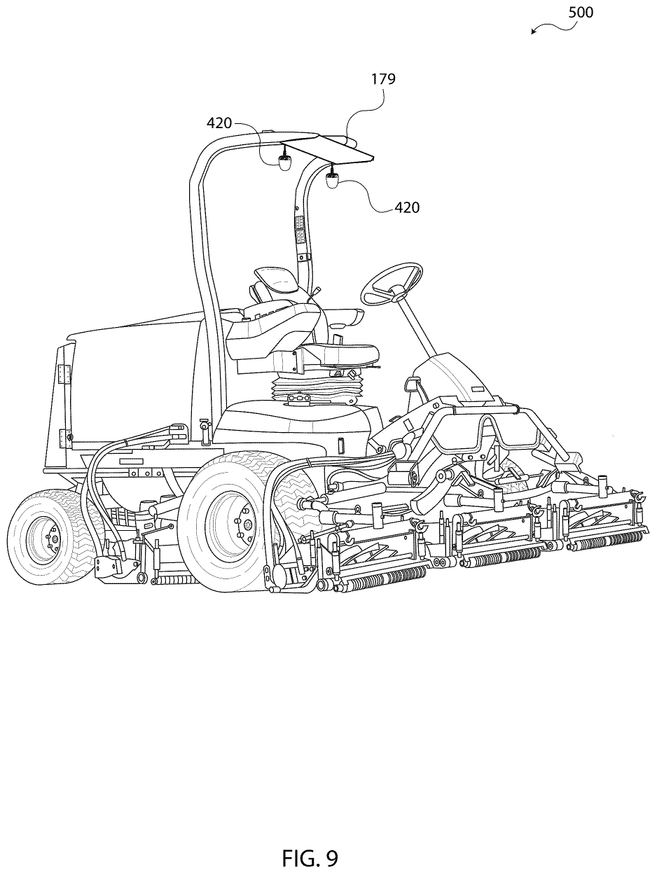

FIG. 9 is a sideview of an example autonomous mower 500, which may include all or some of the components of autonomous work vehicle 110. The autonomous work vehicle in this document may include the autonomous mower 500. In this example, the autonomous mower 500 includes a disc mower 545. Any type of mower or blades may be used instead of the disc mower. The autonomous mower 500, for example, includes a sensor array 179 (or multiple sensor arrays). The sensor array 179 may include, for example, one or more lidar, radar, and/or video cameras. The video cameras, for example, may include 360 degree cameras, a front facing camera, and/or a back facing camera.

The computational system 1000, shown in FIG. 10 can be used to perform any of the examples disclosed in this document. For example, computational system 1000 can be used to execute process 300. As another example, computational system 1000 can perform any calculation, identification and/or determination described here. Computational system 1000 includes hardware elements that can be electrically coupled via a bus 1005 (or may otherwise be in communication, as appropriate). The hardware elements can include one or more processors 1010, including without limitation one or more general-purpose processors and/or one or more special-purpose processors (such as digital signal processing chips, graphics acceleration chips, and/or the like); one or more input devices 1015, which can include without limitation a mouse, a keyboard and/or the like; and one or more output devices 1020, which can include without limitation a display device, a printer and/or the like.

The computational system 1000 may further include (and/or be in communication with) one or more storage devices 1025, which can include, without limitation, local and/or network accessible storage and/or can include, without limitation, a disk drive, a drive array, an optical storage device, a solid-state storage device, such as a random access memory (“RAM”) and/or a read-only memory (“ROM”), which can be programmable, flash-updateable and/or the like. The computational system 1000 might also include a communications subsystem 1030, which can include without limitation a modem, a network card (wireless or wired), an infrared communication device, a wireless communication device and/or chipset (such as a Bluetooth device, an 802.6 device, a Wi-Fi device, a WiMax device, cellular communication facilities, etc.), and/or the like. The communications subsystem 1030 may permit data to be exchanged with a network (such as the network described below, to name one example), and/or any other devices described in this document. The computational system 1000, for example, may include a working memory 1035, which can include a RAM or ROM device, as described above.

The computational system 1000 also can include software elements, shown as being currently located within the working memory 1035, including an operating system 1040 and/or other code, such as one or more application programs 1045, which may include computer programs of the invention, and/or may be designed to implement methods of the invention and/or configure systems of the invention, as described herein. For example, one or more procedures described with respect to the method(s) discussed above might be implemented as code and/or instructions executable by a computer (and/or a processor within a computer). A set of these instructions and/or codes might be stored on a computer-readable storage medium, such as the storage device(s) 1025 described above.

The storage medium, for example, might be incorporated within the computational system 1000 or in communication with the computational system 1000. The storage medium might be separate from a computational system 1000 (e.g., a removable medium, such as a compact disc, etc.), and/or provided in an installation package, such that the storage medium can be used to program a general-purpose computer with the instructions/code stored thereon. These instructions might take the form of executable code, which is executable by the computational system 1000 and/or might take the form of source and/or installable code, which, upon compilation and/or installation on the computational system 1000 (e.g., using any of a variety of generally available compilers, installation programs, compression/decompression utilities, etc.) then takes the form of executable code.

Although term “autonomous work vehicle” includes manned vehicles, remote control vehicles, manual vehicles, etc.

Unless otherwise specified, the term “substantially” means within 5% or 10% of the value referred to or within manufacturing tolerances. Unless otherwise specified, the term “about” means within 5% or 10% of the value referred to or within manufacturing tolerances.

The conjunction “or” is inclusive.

The terms “first”, “second”, “third”, etc. are used to distinguish respective elements and are not used to denote a particular order of those elements unless otherwise specified or order is explicitly described or required.

Numerous specific details are set forth to provide a thorough understanding of the claimed subject matter. However, those skilled in the art will understand that the claimed subject matter may be practiced without these specific details. In other instances, methods, apparatuses or systems that would be known by one of ordinary skill have not been described in detail so as not to obscure claimed subject matter.

Some portions are presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm is a self-consistent sequence of operations or similar processing leading to a desired result. In this context, operations or processing involves physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general-purpose computing apparatus to a specialized computing apparatus implementing one or more examples disclosed in this document. Any suitable programming, scripting, or other type of language or combinations of languages may be used to implement the teachings contained in software to be used in programming or configuring a computing device.

Embodiments of the methods disclosed may be performed in the operation of such computing devices. The order of the blocks presented in the examples above can be varied—for example, blocks can be re-ordered, combined, and/or broken into sub-blocks. Certain blocks or processes can be performed in parallel.

The use of “adapted to” or “configured to” is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included are for ease of explanation only and are not meant to be limiting.

While the present subject matter has been described in detail with respect to specific examples, those skilled in the art, upon attaining an understanding of these examples, may readily produce alterations to, variations of, and equivalents to such examples. Accordingly, the present disclosure has been presented for purposes of example rather than limitation, and does not preclude inclusion of such modifications, variations and/or additions to the present subject matter as would be readily apparent to one of ordinary skill in the art.

1. An autonomous work vehicle comprising:
a vehicle control unit;
a location determining system;
a digital storage medium comprising map data defining:
a map comprising a path for the autonomous work vehicle to travel,
at least one error polygon defined around the autonomous work vehicle within the map; and
a controller in communication with the digital storage medium, location determining system, and the vehicle control unit, wherein the controller performs an off path error check in which the controller:
retrieves the map data from the digital storage medium;
receives current location data from the location determining system;
locates the autonomous work vehicle on the map with the location data;
determines whether the path is within the error polygon around the autonomous work vehicle; and
if the path is not within the error polygon, the vehicle control unit performs a corrective action on the autonomous work vehicle.

2. The autonomous work vehicle according to claim 1, wherein the map data further defines a vehicle polygon having vehicle polygon sides which define boundaries of the autonomous work vehicle within the map.

3. The autonomous work vehicle according to claim 2, wherein sides of the error polygon are defined at a predetermined normal distance from the vehicle polygon sides.

4. The autonomous work vehicle according to claim 3, wherein the predetermined normal distance is based on an allowable off path error.

5. The autonomous work vehicle according to claim 3, wherein the predetermined normal distance is variable around the autonomous work vehicle.

6. The autonomous work vehicle according to claim 4, wherein the allowable off-path error is variable around the autonomous work vehicle.

7. The autonomous work vehicle according to claim 1, wherein a hazard polygon is defined around the vehicle polygon and defines a hazard zone between the vehicle polygon and the hazard polygon, and wherein the controller determines whether an obstacle is located within the hazard zone, and if an obstacle is located within the hazard zone, the vehicle control system performs corrective action on the autonomous work vehicle.

8. The autonomous work vehicle according to claim 4, wherein the allowable off path error is dynamically adjusted dependent on the location of the autonomous work vehicle on the map.

9. The autonomous work vehicle according to claim 1, wherein the map data comprises at least two error polygons, wherein each error polygon comprises a different shape.

10. The autonomous work vehicle according to claim 9, wherein an error polygon, from the at least two error polygons, is selected based on the location of the autonomous work vehicle on the map.

11. The autonomous work vehicle according to claim 1, wherein the map comprises undrivable zones defined as areas in which the autonomous work vehicle may not travel, and wherein the controller:
determines whether the error polygon intersects an undrivable zone, and
if the error polygon intersects an undrivable zone, the vehicle control system performs corrective action on the autonomous work vehicle.

12. The autonomous work vehicle according to claim 1, wherein performing a corrective action on the autonomous work vehicle comprises:
reducing the speed of the autonomous work vehicle, including stopping the autonomous work vehicle and/or
steering the autonomous work vehicle back to the path.

13. A method of controlling an autonomous work vehicle, the method comprising:
receiving location data from a location determining system on the autonomous work vehicle,
receiving map data defining:
a map comprising a path for the autonomous work vehicle to travel; and
at least one error polygon defined around the autonomous work vehicle within the map;
locating the autonomous work vehicle on the map with the location data;
determining whether the path is within the error polygon; and
if the path is not within the error polygon, performing a correction action on the autonomous work vehicle.

14. The method according to claim 13, wherein the map data further defines a vehicle polygon having vehicle polygon sides which define boundaries of the autonomous work vehicle within the map, and wherein sides of the error polygon are defined at a predetermined normal distance from the vehicle polygon sides.

15. The method according to claim 13, wherein a hazard polygon is defined around the vehicle polygon and defines a hazard zone between the vehicle polygon and the hazard polygon, and wherein the method comprises:
determining whether an obstacle is located within the hazard zone, and
if an obstacle is located within the hazard zone, performing a corrective action on the autonomous work vehicle.

16. The method according to claim 14, wherein the predetermined normal distance is based on an allowable off path error, the method further comprising:
dynamically adjusting the allowable off path error based on the location of the autonomous work vehicle on the map.

17. The method according to claim 12, wherein the map data comprises at least two error polygons, the method further comprising:
selecting an error polygon based on the location of the autonomous work vehicle on the map.

18. The method according to claim 12, wherein the map comprises undrivable zones defined as areas in which the autonomous work vehicle may not travel, wherein the method comprises:
determining whether the error polygon intersects an undrivable zone; and
if the error polygon intersects an undrivable zone, performing a corrective action on the autonomous work vehicle.

19. The method according to claim 12, wherein performing a corrective action on the autonomous work vehicle comprises:
reducing the speed of the autonomous work vehicle, including stopping the autonomous work vehicle; and
steering the autonomous work vehicle back to the path.

20. A method of planning a route for an autonomous work vehicle, the method comprising:
receiving map data defining:
a map comprising a path for the autonomous work vehicle to travel,
undrivable zones and/or obstacles on the map, the undrivable zones defined as areas in which the autonomous work vehicle may not travel, and
at least one error polygon defined around the autonomous work vehicle within the map;
generating a first plan for the autonomous work vehicle to follow the path with a maximum size error polygon;
performing a plan check comprising:
reviewing whether the error polygon intersects an undrivable zone and/or an obstacle at any point in the plan, and
if the error polygon intersects an undrivable zone and/or an obstacle at any point in the plan, generating a new plan reducing the size of the error polygon where it intersects the undrivable zone and/or the obstacle; and
if a new plan is generated when performing the plan check, repeating the plan check with the new plan.
